(19) United States
(12) Patent Application Publication
(10) Pub. No.: US 2018/0067710 A1
(43) Pub. Date: Mar. 8, 2018

(54) FOIL STAMPING SYSTEM, FOIL STAMPING CONTROL METHOD, AND FOIL STAMPING CONTROL PROGRAM

(71) Applicant: Konica Minolta, Inc., Tokyo (JP)

(72) Inventor: Yoshio MIYAMOTO, Tokyo (JP)

(73) Assignee: Konica Minolta, Inc., Tokyo (JP)

(21) Appl. No.: 15/677,557

(22) Filed: Aug. 15, 2017

(30) Foreign Application Priority Data
Sep. 6, 2016 (JP) 2016-173422

(51) Int. Cl. G06F 3/12

(52) U.S. Cl. CPC G06F 3/1286; B41F 16/0046; G06F 3/1208; G06F 3/1257

(57) ABSTRACT

A foil stamping system includes a foil stamping apparatus capable of arranging and mounting a plurality of foil rolls about a direction orthogonal to a sheet feeding direction for forming a foil image by applying an adhesive on the sheet and stamping foil thereon, and a hardware processor, wherein the hardware processor includes: a foil roil information acquisitor that acquires foil roll information from the foil stamping apparatus; a job information acquisitor that receives and analyzes a job, and acquires job information; and an instructor that specifies a foil roll on the basis of the foil roll information and the job information transmits data for designating the region to be applied to the foil stamping apparatus, and instructs the foil stamping apparatus to perform foil stamping by the specified foil roll.

Japanese Patent Application No. 2016-173422 filed on Sep. 6, 2016, including description, claims, drawings, and abstract the entire disclosure is incorporated herein by reference in its entirety.

### BACKGROUND

### Technological Field

The present invention relates to a foil stamping system, a foil stamping control method, and a foil stamping control program, and particularly to a foil stamping system for forming a foil image by applying an adhesive and stamping foil on a sheet, a foil stamping control method for controlling foil stamping, and a foil stamping control program.

### Description of the Related art

There has been generally known a foil stamping apparatus capable of giving additional value to a printed material by applying an adhesive such as varnish on the printed material and pressing/heating foil such as gold or silver on the printed material. The foil pressed/heated on the printed material cannot be kept in its initial shape due to heat and cannot be reused, and thus there has been also known a foil stamping apparatus for restricting the amount of discarded by enabling a plurality of foil rolls narrower than a maximum feedable size (width) of a material to be printed to be set and enabling the foil rolls to be independently operated, stopped and pressed thereby to operate only a foil roll at a portion to be foil-stamped.

For such a foil stamping apparatus, for example, JP 2006-224667 A discloses an apparatus for transferring an image giving layer from transfer foil onto a sheet to be printed by at least one covering mechanism for transferring the image giving layer from the transfer foil onto the sheet to be printed at a transfer slit between opposite cylinders and a press roller, the apparatus including a device capable of attaching a side to be covered of the transfer foil to the sheet to be printed and guiding it via the transfer slit, capable of moving the image giving layer onto the sheet to be printed in order to form an image thereon, and directed for supplying and discharging the transfer fail to and from the covering mechanism, the device including a drive unit for moving the transfer foil in a working direction, and the apparatus being such that the device for supplying the transfer foil is attached with one or more independent beating devices for receiving one or more partial foil rolls of the transfer foil from which a train of partial foil is fed while being supplied to the transfer slit.

It is possible to reduce the amount of discarded foil by operating only a foil roll matching with a region to be foil-stamped among a plurality of foil rolls in a typical foil stamping apparatus. However, when the foil roll matching with the region to be foil-stamped is used up, the foil stamping apparatus needs to temporarily stop operating thereby to replace with a new foil roil and then the foil stamping apparatus needs to restart operating. Therefore, there is a problem that a period in which the foil stamping apparatus does not operate is caused, and productivity of output materials is reduced.

### SUMMARY

The present invention has been made in terms of the above problem, and a main object thereof is to provide a foil stamping system, a foil stamping control program, and a foil stamping control method.

To achieve the abovementioned object, according to an aspect of the present invention, a foil stamping system reflecting one aspect of the present invention comprises a foil stamping apparatus capable of arranging and mounting a plurality of foil rolls about a direction orthogonal to a sheet feeding direction of a sheet in plane of the sheet and directed for forming a foil image by applying an adhesive on the sheet and stamping foil thereon, and a hardware processor, wherein the hardware processor includes: a foil roll information acquisitor that acquires foil roll information including position, width, and the amount of remaining foil of each of the foil rolls from the foil stamping apparatus; a job information acquisitor that receives and analyzes a job, and acquires job information including size of a sheet used for processing the job, and position and size of a region to be applied with the adhesive in order to form the foil image based on the job on the sheet; and an instructor that specifies a foil roll having the amount of remaining foil equal to or longer than the region to be applied in the sheet feeding direction and with a width equal to or larger than the region to be applied in the axial direction from the foil rolls on the basis of the foil roll information and the job information, transmits data for designating the region to be applied to the foil stamping apparatus, and instructs the foil stamping apparatus to perform foil stamping by the specified foil roll.

### BRIEF DESCRIPTION OF THE DRAWING

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram illustrating an exemplary configuration of a foil stamping system according to a first embodiment of the present invention;

FIGS. 2A and 2B are block diagrams illustrating a configuration of a job generation apparatus according to the first embodiment of the present invention;

FIGS. 3A and 3B are block diagrams illustrating a configuration of a controller according to the first embodiment of the present invention;

FIG. 4 is a block diagram illustrating a configuration of a foil stamping apparatus according to the first embodiment of the present invention;

FIG. 5 is a schematic diagram for explaining a typical foil stamping method;

FIG. 6 is a schematic diagram for explaining a foil stamping method (method for rotating a region to be applied by 180 degrees) according to the first embodiment of the present invention;

FIG. 7 is a schematic diagram for explaining the oil stamping method (method for moving a foil roll) according to the first embodiment of the present invention;

FIG. 8 is a schematic diagram for explaining the foil stamping method (method for moving a sheet feeding path) according to the first embodiment of the present invention;

FIG. 9 is a schematic diagram for explaining the foil stamping method (method using a plurality of foil rolls) according to the first embodiment of the present invention;

FIG. 10 is a flowchart illustrating the operations of the controller according to the first embodiment of the present invention;

FIG. 11 is a schematic diagram illustrating a configuration of a foil stamping system according to a second embodiment of the present invention;

FIG. 12 is a block diagram illustrating a configuration of an image forming apparatus according to the second embodiment of the present invention;

FIG. 13 is a schematic diagram for explaining a typical foil stamping method;

FIG. 14 is a schematic diagram for explaining a foil stamping method (method for rotating region to be applied by 180 degrees) according to the second embodiment of the present invention;

FIG. 15 is a schematic diagram for explaining the foil stamping method (method for rotating and mounting a printed sheet by 180 degrees) according to the second embodiment of the present invention;

FIG. 16 is a schematic diagram for explaining the foil stamping method (method for moving a foil roil) according to the second embodiment of the present invention;

FIG. 17 is a schematic diagram for explaining the foil stamping method (method for moving a sheet feeding path) according to the second embodiment of the present invention;

FIG. 18 is a schematic diagram for explaining the foil stamping method (method using a plurality of foil rolls) according to the second embodiment of the present invention; and

FIG. 19 is a flowchart illustrating the operations of the controller according to the second embodiment of the present invention.

### DETAILED DESCRIPTION OF EMBODIMENTS

Hereinafter, one or more embodiments of the present invention will be described with reference to the drawings. However, the scope of the invention is not limited to the disclosed embodiments.

As described in Description of the Related art, there has been known a foil stamping apparatus for giving additional value to a printed material by applying an adhesive such as varnish on the printed material and pressing/heating foil such as gold or silver thereon. Further, there has been also known a foil stamping apparatus for reducing the amount of discarded foil by enabling a plurality of foil rolls narrower than a maximum feedable size (width) of a printed material to be set, enabling the foil rolls to be independently operated, stopped and pressed, and operating only a foil roll at a portion to be foil-stamped.

When a foil roll at a portion to be foil-stamped is used up, however, the foil stamping apparatus needs to temporarily stop operating, the foil roll needs to be replaced with a new foil roll, and then the foil stamping apparatus needs to restart operating. There is therefore a problem that a period in which the foil stamping apparatus does not operate is caused and productivity of output materials is reduced.

Thus, according to one embodiment of the present invention, in a foil stamping system including a foil stamping apparatus capable of arranging and mounting a plurality of foil rolls about a direction orthogonal to a sheet feeding direction of a sheet in plane of the sheet and capable of independently operating each foil roll, there is specified a foil roil having the amount of remaining foil equal to or longer than a region to be applied in the sheet feeding direction and having a width equal to or larger than the region to be applied in the axial direction from among the foil rolls on the basis of foil roll information on position, width, and the amount of remaining foil of each mounted foil roll and job information on position and size of the region to be varnish-applied (region to be applied). Then, foil stamping is controlled so as to be performed by the specified foil roll by rotating the region to be applied, moving the foil rolls in the axial direction, or moving the sheet feeding path of the sheet to be foil-stamped in the axial direction.

The number of times of replacement of foil rolls can be reduced under the control, thereby restricting a reduction in productivity of output materials due to replacement of foil rolls. Further, even when a deviation in the remaining amounts of foil rolls can be restricted and any foil roll is used up, other foil roll can be subsequently used, thereby restricting a reduction in productivity of output materials due to replacement of foil rolls.

### First Embodiment

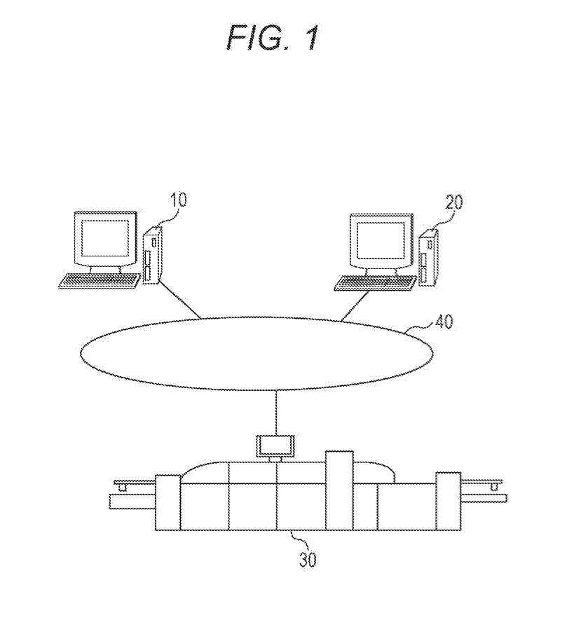

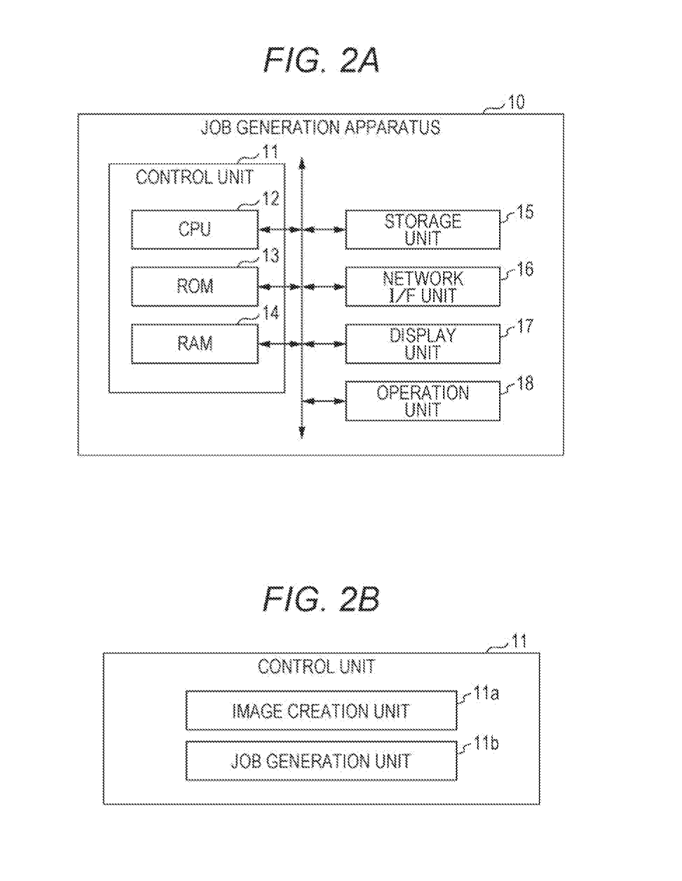

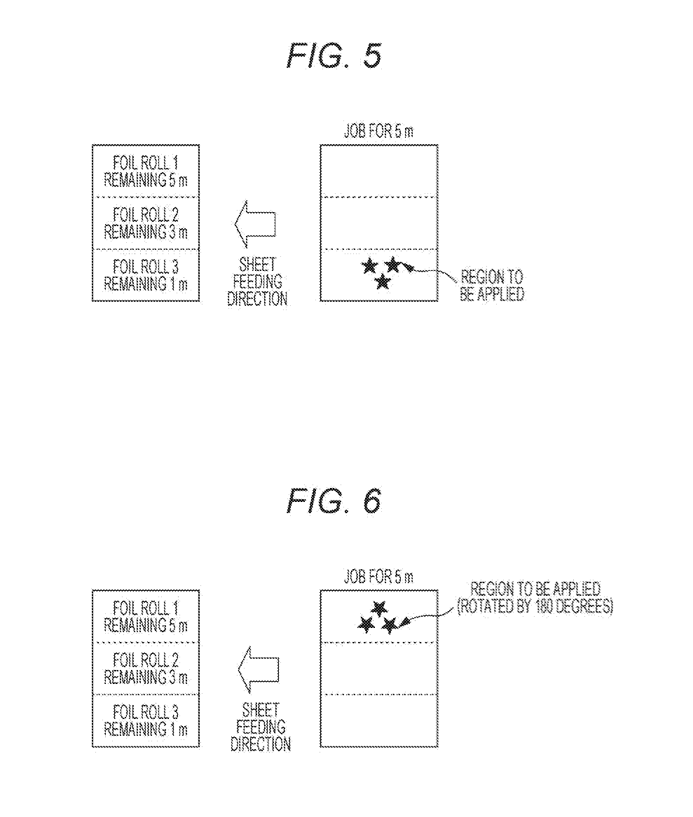

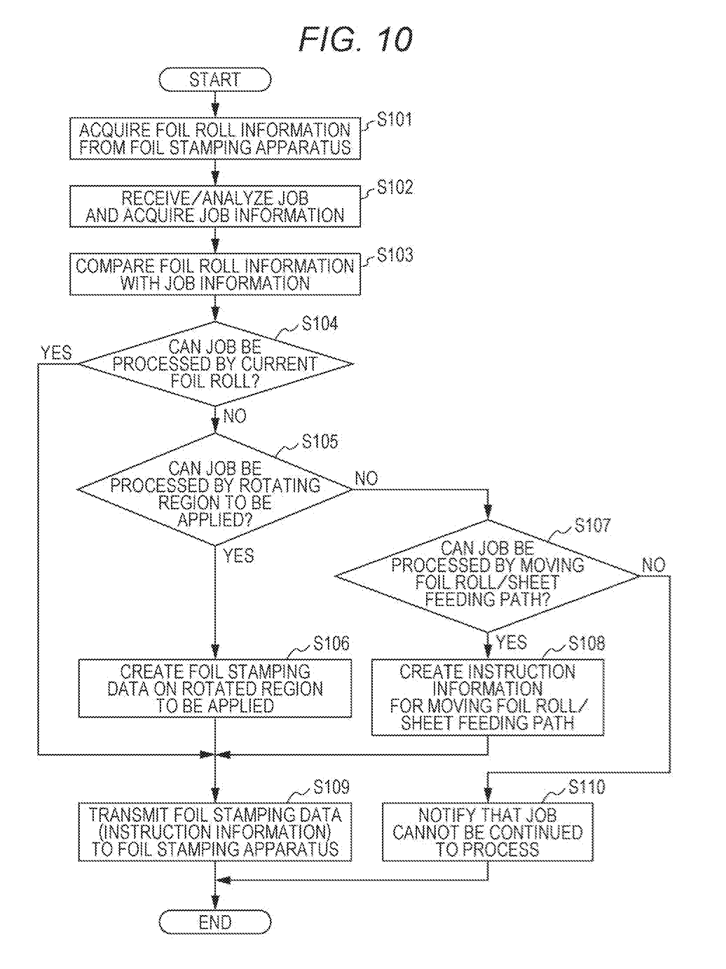

A foil stamping system, a foil stamping control program, and a foil stamping control method according to a first embodiment of the present invention will be described with reference to FIGS. 1 to 10 in order to describe embodiments of the present invention in more detail. FIG. 1 is a schematic diagram illustrating a configuration of a foil stamping system according to the present embodiment, and FIGS. 2A to 4 are block diagrams illustrating the configurations of a job generation apparatus, a controller and a foil stamping apparatus according to the present embodiment, respectively. FIGS. 5 to 9 are schematic diagrams for explaining a foil stamping method, and FIG. 10 is a flowchart illustrating the operations of the controller according to the present embodiment.

As illustrated in FIG. 1, the foil stamping system according to the present embodiment is configured of a job generation apparatus 10 for generating and transmitting a job, a controller 20 for processing the job, and a foil stamping apparatus 30 for forming a foil image on a sheet on the basis of the job. The components are connected via a communication network 40 such as local area network (LAN) or wide area network (WAN) defined by a standard such as Ethernet (trademark), token ring, or fiber-distributed data interface (FDDI).

FIG. 1 illustrates that the foil stamping system is configured of the job generation apparatus 10, the controller 20, and the foil stamping apparatus 30, but if the functions of the controller 20 can be realized by the job generation apparatus 10 or the foil stamping apparatus 30, the controller 20 can be omitted. Each apparatus will be described below in detail assuming the configuration in FIG. 1.

### [Job Generation Apparatus]

The job generation apparatus 10 is a computer apparatus (client apparatus) such as personal computer, and generates a job and transmits the job to the controller 20. The job generation apparatus 10 is configured of a control unit 11, a storage unit 15, a network I/F unit 16, a display unit 17, an operation unit 18, and the like as illustrated in FIG. 2A.

The control unit 11 is configured of a central processing unit (CPU) 12 and a memory such as read only memory (ROM) 13 or random access memory (RAM) 14, and the CPU 12 develops a control program stored in the ROM 13 or the storage unit 15 into the RAM 14 and executes the control program thereby to control the operations of the entire job generation apparatus 10. The control unit 11 functions as an image creation unit 11a or a job generation unit 11b as illustrated in FIG. 2B.

The image creation unit 11a designates a region to be applied with an adhesive such as varnish (which will be simply denoted as region to be applied) in order to form a foil image, or the like.

The job generation unit 11b creates tagged image file format (TIFF) data or the like (denoted as stamping data) for designating a region to be applied, and outputs a job including the foil stamping data to the controller 20.

The storage unit 15 is configured of hard disk drive (HDD), solid state drive (SSD), or the like, and stores the program used by the CPU 12 for controlling each unit, information on the processing functions of the apparatus, jobs, and the like.

The network I/F unit 16 is configured of network interface card (NIC), modem, or the like, connects the job generation apparatus 10 to the communication network 40, and transmits a job to the controller 20.

The display unit 17 is configured of liquid crystal display (LCD), organic electroluminescence (EL) display, or the like, and displays a screen for designating a region to be applied, a screen for processing a job, and the like.

The operation unit 18 is configured of mouse, keyboard, or the like, and enables the operations such as designating a region to be applied or transmitting a job.

### [Controller]

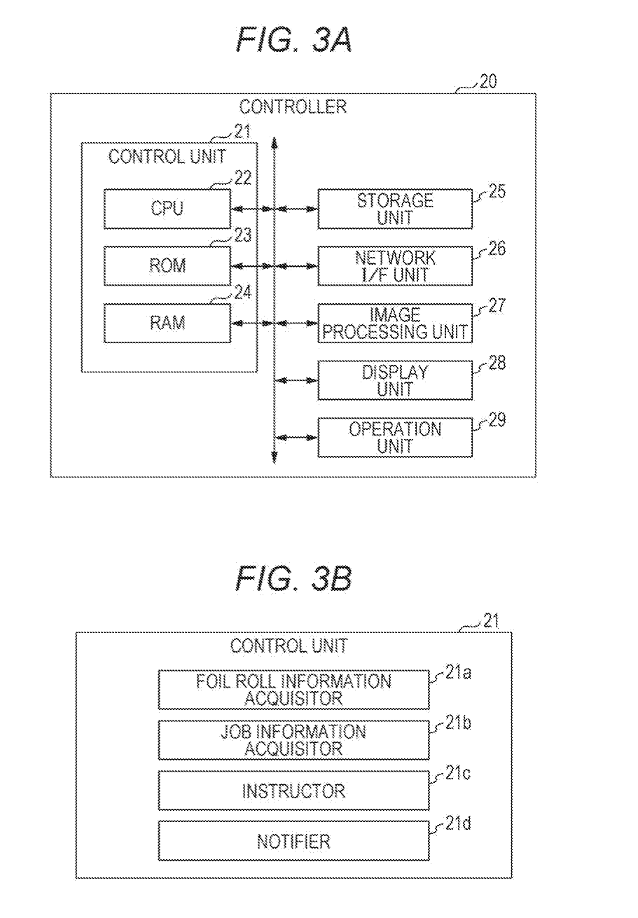

The controller 20 is a printer controller, print server, or the like, and instructs to store a job received from the job generation apparatus 10 and to transmit the foil stamping data to the foil stamping apparatus 30 for foil stamping. The controller 20 is configured of a control unit 21, a storage unit 25, a network I/F unit 26, an image processing unit 27, a display unit 28, an operation unit 29, and the like as illustrated in FIG. 3A.

The control unit 21 is configured of a CPU 22 and a memory such as ROM 23 or RAM 24, and the CPU 22 develops a control program stored in the ROM 23 or the storage unit 25 into the RAM 24 and executes the control program thereby to control the operations of the entire controller 20. The control unit 21 functions as a foil roll information acquisitor 21a, a job information acquisitor 21b, an instructor 21c, a notifier 21d, and the like as illustrated in FIG. 3B.

The foil roll information acquisitor 21a acquires information (which will be denoted as foil roil information below) including position, width and the amount of remaining foil of each mounted foil roll from the foil stamping apparatus 30.

The job information acquisitor 21b analyzes a job received from the job generation apparatus 10, and acquires information (which will be denoted as job information below) including size of a sheet used for processing the job, position and size of a region to be applied on the sheet (length of the sheet in the sheet feeding direction or length of a foil roll in the axial direction), and the like.

The instructor 21c determines a foil stamping method capable of further reducing the number of times of replacement of foil rolls on the basis of the foil roil information and the job information. Specifically, the instructor 21c specifies a foil roll having the amount of remaining foil equal to or longer than a region to be applied in the sheet feeding direction and having a width equal to or larger than the length of the region to be applied in the axial direction from among the foil rolls, transmits image data (foil stamping data) for designating the region to be applied to the foil stamping apparatus 30, and instructs to stamp foil by the specified foil roll. At this time, when the region to be applied is rotated on the sheet and the rotated region to be applied is within the region to be foil-stamped by the specified foil roil, the foil stamping data for designating the rotated region to be applied is transmitted to the foil stamping apparatus 30. Further, when a plurality of foil rolls are moved in the axial direction and the region to be applied is within the region to be foil-stamped by the specified foil roll, the foil stamping data is transmitted to the foil stamping apparatus 30 and instruction information for instructing to move the foil rolls is transmitted thereto. Further, when the sheet feeding path of the sheet is moved in the axial direction and the region to be applied is within the region to be foil-stamped by the specified foil roll during foil stamping, the foil stamping data is transmitted to the foil stamping apparatus 30 and instruction information for instructing to move the sheet feeding path of the sheet is transmitted thereto. Additionally, two or more foil rolls, for which the total amount of remaining foil is equal to or longer than the region to be applied in the sheet feeding direction, may be specified from among the foil rolls, and in this case, the two or more foil rolls are designated in a predetermined order and the foil stamping apparatus 30 is sequentially instructed to stamp foil by the designated foil rolls.

When the instructor 21c cannot specify a foil roll or when the job cannot be processed without replacement of foil rolls even by rotating the region to be applied, moving the foil rolls in the axial direction, or moving the sheet feeding path of the sheet in the axial direction, the notifier 21d displays a message that the foil roll needs to be replaced for processing the job on the display unit 28 and notifies it to the user.

The foil roll information acquisitor 21a, the job information acquisitor 21b, the instructor 21c, and the notifier 21d may be configured in hardware, and the control unit 21 may be configured as a foil stamping control program for functioning as the foil roll information acquisitor 21a, the job information acquisitor 21b, the instructor 21c, and the notifier 21d thereby to cause the CPU 22 to execute the foil stamping control program.

The storage unit 25 is configured of HDD, SSD, or the like, and stores the program used by the CPU 22 for controlling each unit, the jobs received from the job generation apparatus 10, and the foil stamping data transmitted to the foil stamping apparatus 30.

The network I/F unit 26 is configured of NIC, modem, or the like, connects the controller 20 to the communication network 40, receives a job from the job generation apparatus 10, receives the foil roll information from the foil stamping apparatus 30, and transmits the foil stamping data to the foil stamping apparatus 30.

The image processing unit 27 functions as a raster image processor (RIP), translates a job thereby to generate intermediate data, and performs rendering thereby to generate image data in the bitmap form (a, series of processing will be denoted as RIP processing). Further, the image processing unit 27 performs screen processing, tone correction, density balance adjustment, thinning, halftone dot processing, and the like on the image data in the bitmap form as needed.

The display unit 28 is configured of liquid crystal display, organic EL display, or the like, and displays the above message in response to an instruction of the notifier 21d or displays a screen for causing the user to designate an order of using the foil rolls.

The operation unit 29 is configured of mouse, keyboard, or the like, and. enables an operation on the above message or an operation of designating an order of using the foil rolls.

### [Foil Stamping Apparatus]

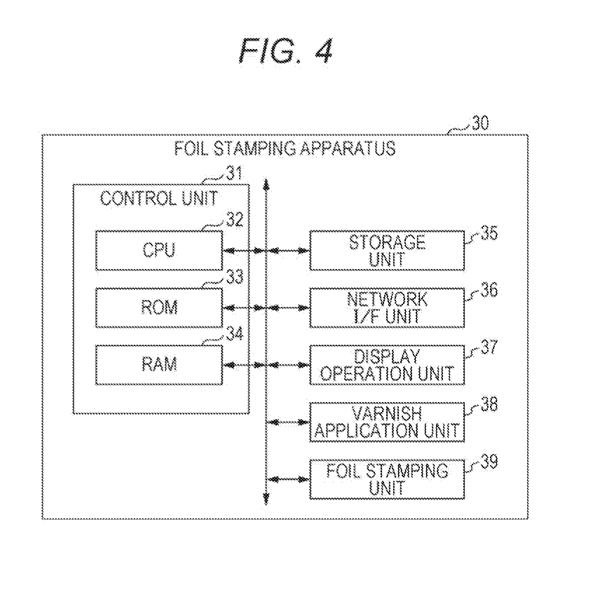

The foil stamping apparatus 30 performs varnish application and foil stamping. The foil stamping apparatus 30 is configured of a control unit 31, a storage unit 35, a network I/F unit 36, a display operation unit 37, a varnish application unit 38, a foil stamping unit 39, and the like as illustrated in FIG. 4.

The control unit 31 is configured of a CPU 32 and a memory such as ROM 33 or RAM 34, and the CPU 32 develops a control program stored in the ROM 33 or the storage unit 35 into the RAM 34 and executes the control program thereby to control the operations of the entire foil stamping apparatus 30. In particularly, foil stamping by the foil stamping unit 39 is controlled and the amount of remaining foil of each foil roll is acquired on the basis of the amount of used foil.

The storage unit 35 is configured of HDD, SSD, or the like, and stores the program used by the CPU 32 for controlling each unit, information on the processing functions of the apparatus, the foil roll information transmitted to the controller 20, the foil stamping data received from the controller 20, and the like.

The network I/F unit 36 is configured of NIC, modem, or the like, connects the foil stamping apparatus :30 to the communication network 40, transmits the foil roll information to the controller 20, and receives the foil stamping data from the controller 20.

The display operation unit 37 is a touch panel provided with a pressure-sensitive operation unit (touch sensor) in which transparent electrodes are arranged in a grid shape on the display unit, displays various screens for the foil stamping processing, and enables various operations for the foil stamping processing.

The varnish application unit 38 applies an adhesive such as varnish on a region to be applied defined by the foil stamping data on a sheet.

The foil stamping unit 39 includes a mounting unit capable of arranging and mounting a plurality of foil rolls about a direction orthogonal to the sheet feeding direction of a sheet in plane of the sheet, and stamps foil on the sheet by use of a plurality of foil rolls of the same color thereby to press foil on a region to be applied with the adhesive and to form a foil image. The foil rollers can independently operate, respectively. Further, the foil stamping unit 39 is configured such that the foil rollers can be moved in the axial direction of the foil rollers or configured such that the sheet feeding path of a sheet can be moved in the axial direction of the foil rollers during foil stamping, and moves the foil rollers in the axial direction or moves the sheet feeding path of a sheet in the axial direction in response to an instruction of the controller 20.

FIGS. 1 to 4 illustrate the foil stamping system according to the present embodiment by way of example, and the structure and control of each apparatus can be changed as needed.

For example, FIGS. 3A and 3B illustrate that the control unit 21 in the controller 20 is configured to function as the foil roll information acquisitor 21a, the job information acquisitor 21b, the instructor 21c and the notifier 21d (to cause the CPU 22 in the controller 20 to execute the foil stamping control program), but the control unit 31 in the foil stamping apparatus 30 may be configured to function as a foil roll information acquisitor, a job information acquisitor, an instructor, and a notifier (to cause the CPU 32 in the foil stamping apparatus 30 to execute the foil stamping control program).

Further, FIG. 4 illustrates that the foil stamping apparatus 30 is provided with the varnish application unit 38 and the foil stamping unit 39, but the foil stamping apparatus 30 may be separated into a varnish application apparatus including a varnish application unit and a foil stamping apparatus including a foil stamping unit.

A foil stamping method according to the present embodiment will be described below. At first, the controller 20 transmits the foil stamping data to the foil stamping apparatus 30, and the varnish application unit 38 in the foil stamping apparatus 30 applies varnish on a sheet according to the foil stamping data. Thereafter, the foil stamping unit 39 in the foil stamping apparatus 30 presses/heats a foil roll on the varnish-applied sheet thereby to perform foil stamping.

Here, assuming that three foil rolls (foil rolls 1 to 3) are mounted on the foil stamping unit 39 as illustrated in FIG. 5, it is assumed that the amount of remaining foil of the foil roil 1 is 5 m, the amount of remaining foil of the foil roll 2 is 3 m, and the amount of remaining foil of the foil roll 3 is 1 m. Further, there will be considered a case in which a job for 5 m, in which a region to be applied (black star in the Figure) corresponding to the foil roll 3 is instructed to apply varnish, is processed. In this case, only the foil roll 3 may be used in the correspondence between the varnish-applied region and the region to be foil-stamped by the foil roll, but the amount of remaining foil of the foil roll 3 is only 1 m for the 5-m job, and thus the foil roll 3 needs to be replaced during the job and productivity of output materials is reduced.

Thus, according to the present embodiment, a first method is that the control unit 21 (the instructor 21c) in the controller 20 specifies a foil roll with the amount of remaining foil required for processing the job (the remaining amount is 5 m or more here) on the basis of the foil roll information (such as position, width and the amount of remaining foil of each foil roll) and the job information (such as size of a sheet, and position and size of a region to be applied on the sheet), and transmits the foil stamping data on the rotated region to be applied (rotated by 180 degrees here) to the foil stamping apparatus 30 in order to establish a correspondence between the region to be foil-stamped by the specified foil roll (the foil roll 1 here) and the varnish-applied region as illustrated in FIG. 6. The varnish application unit 38 in the foil stamping apparatus 30 then applies varnish according to the foil stamping data, and the foil stamping unit 39 operates the foil roll corresponding, to the varnish-applied region thereby to perform foil stamping. Thereby, the foil roll does not need to be replaced for processing the job, and thus productivity of output materials can be improved.

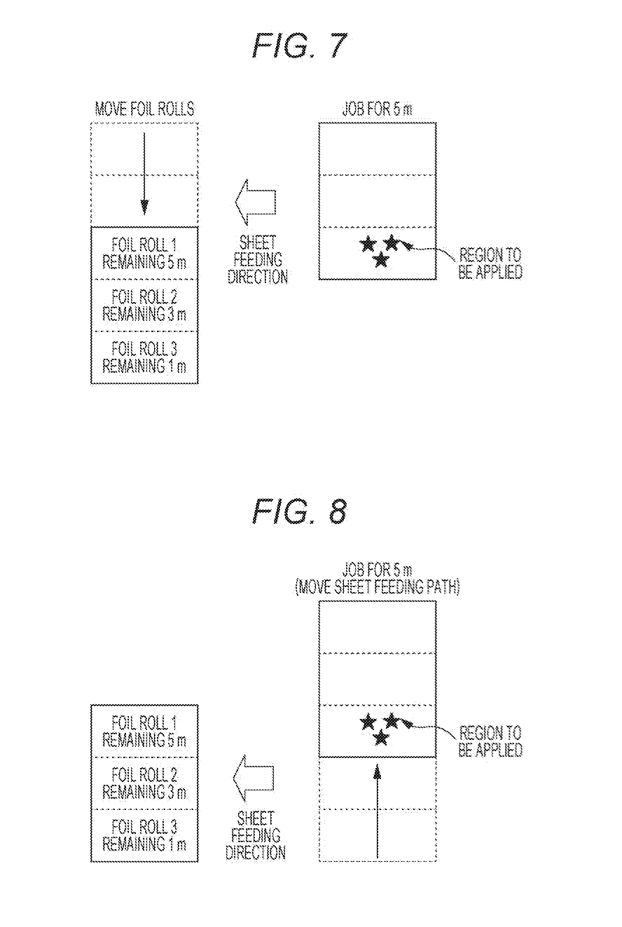

Further, a second method is that when the foil stamping unit 39 is configured such that a plurality of foil rolls can be moved in the axial direction, the control unit 21 (the instructor 21c) specifies a foil roll with the amount of remaining foil required for processing the job on the basis of the foil roll information and the job information, transmits the foil stamping data to the foil stamping apparatus 30 and transmits the instruction information for instructing to move the foil rolls thereto in order to establish a correspondence between the region to be foil-stamped by the specified foil roil and the varnish-applied region as illustrated in FIG. 7. The varnish application unit 38 in the foil stamping apparatus 30 then applies varnish on a sheet according to the foil stamping data, and the foil stamping unit 39 in the foil stamping apparatus 30 moves the foil rolls according to the instruction information and operates a foil roll corresponding to the varnish-applied region thereby to perform foil stamping. Also in the method, the foil roll does not need to be replaced for processing the job, and thus productivity of output materials can be improved.

Further, a third method is that when the foil stamping unit 39 is configured such that the sheet feeding path of a sheet can be moved in the axial direction of the foil rolls, the control unit 21 (the instructor 21c) specifies a foil roll with the amount of remaining foil required for processing the job on the basis of the foil roll information and the job information, and transmits the foil sampling data to the foil stamping apparatus 30 and transmits the instruction information for instructing to move the sheet feeding path in order to establish a correspondence between the region to be foil-stamped by the specified foil roll and the varnish-applied region as illustrated in FIG. 8. The varnish application unit 38 in the foil stamping apparatus 30 then applies varnish on the sheet according to the foil stamping data, and the foil stamping unit 39 in the foil stamping apparatus 30 moves the sheet feeding path of the sheet according to the instruction information and operates a foil roll corresponding to the varnish-applied region thereby to perform foil stamping. Also in the method, the foil roll does not need to be replaced for processing the job, and thus productivity of output materials can be improved.

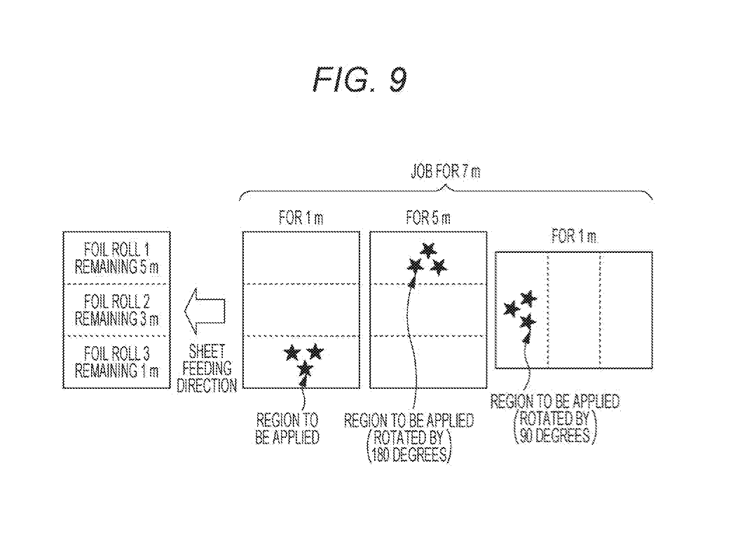

FIGS. 6 to 8 illustrate that a job capable of being processed by only one foil roll is processed, but when the length of a region to be applied designated by the job in the sheet feeding direction is longer than the amount of remaining foil of any foil roll, the above methods can be combined thereby to process the job by sequentially using the foil rolls. For example, when a job for 7 m is processed as illustrated in FIG. 9, there can be configured such that the job for 1 m is processed by the foil roll 3, the job for the next 5 m is that the region to be applied is rotated by 180 degrees in the first method and processed by another foil roll (the foil roll 1 here), and the job for the remaining 1 m is that the region to be applied is rotated by 90 degrees in the first method and processed by the other foil roll (the foil roll 2 here).

When the foil rolls are sequentially used, an order of using the foil rolls can be designated by the user on the screen displayed on the display unit 28 or can be designated in any order (descending or ascending order, for example), and the foil rolls can be sequentially used from a foil roll with the least amount of remaining foil, or can be sequentially used from a foil roll with the most amount of remaining foil, or can be used to be the almost-uniform amounts of remaining foil.

The operations of the controller 20 according to the present embodiment will be described below in detail. The CPU 22 develops the foil stamping control program stored in the ROM 23 or the storage unit 25 into the RAM 24 and executes the control program thereby to perform the processing in each step illustrated in the flowchart of FIG. 10.

At first, the control unit 21 (the foil roll information acquisitor 21a) acquires the foil roll information on position, width, and the amount of remaining foil of each foil roll mounted on the foil stamping unit 39 from the foil stamping apparatus 30 (S101).

The control unit 21 (the job information acquisitor 21b) then receives a job from the job generation apparatus 10 and analyzes the job, and acquires the job information on size of a sheet used for processing the job, position and size of a region to be applied on the sheet, and the like (S102).

The control unit 21 (the instructor 21c) then compares the foil roll information with the job information (S103), and determines whether the job can be processed by a current foil roll (whether foil stamping for the length designated by the job can be performed without replacement of the foil roll) (S104). When the job can be processed by the current foil roll (Yes in S104), rotation of the region to be applied or movement of the foil roll/sheet feeding path is not required, and thus the control unit 21 (the instructor 21c) transmits the foil stamping data included in the job to the foil stamping apparatus 30 (S109).

When the job cannot be processed by the current foil roll (No in S104), the control unit 21 (the instructor 21c) determines whether the job can he processed by rotating the region to be applied (S105). When the job can be processed by rotating the region to be applied (Yes in S105), the control unit 21 (the instructor 21c) creates the foil stamping data on the rotated region to be applied (S106), and transmits the created foil stamping data to the foil stamping apparatus 30 (S109).

On the other hand, when the job cannot be processed even by rotating the region to be applied (No in S105), the control unit 21 (the instructor 21c) determines whether the job can be processed by moving the foil roll or the sheet feeding path in the axial direction (S107). When the job can be processed by moving the foil roll/sheet feeding path (Yes in S107), the control unit 21 (the instructor 21c) creates the instruction information for moving the foil roll/sheet feeding path in the axial direction (S108), and transmits the foil stamping data, included in the job and the created instruction information to the foil stamping apparatus 30 (S109).

Further, when the job cannot be processed even by moving the foil roll/sheet feeding path (No in S107), the control unit 21 (the notifier 21d) displays a message that the job cannot be continued to process (tile foil roil needs to be replaced for processing the job) on the display unit 28, and notifies it to the user (S110).

The foil stamping apparatus 30 receives the foil stamping data and as needed, the instruction information from the controller 20, the varnish application unit 38 applies an adhesive such as varnish on the sheet according to the foil stamping data, and the foil stamping unit 39 moves the foil roll/sheet feeding path in the axis direction according to the instruction information as needed, and, performs foil stamping by a predetermined foil roll thereby to form a foil image.

In this way, according to the present embodiment, a region to be applied is rotated or a foil roll/sheet feeding path is moved to control foil stamping in order to further reduce the number of times of replacement of foil rolls on the basis of the foil roil information acquired from the foil stamping apparatus 30 and the job information acquired by analyzing a job, thereby restricting operation stop of the foil stamping apparatus due to used-up foil roll and improving productivity of output materials.

### Second Embodiment

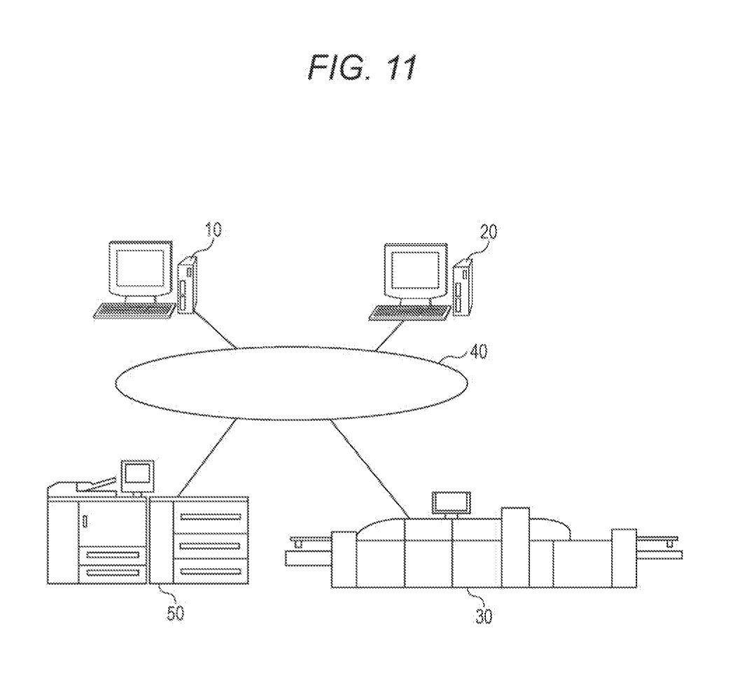

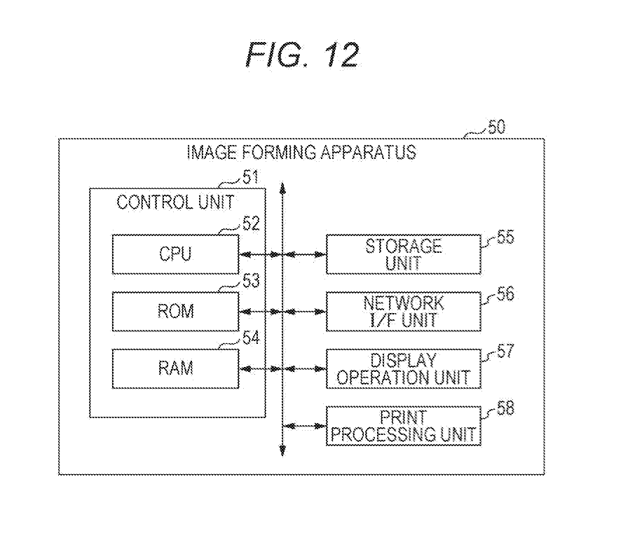

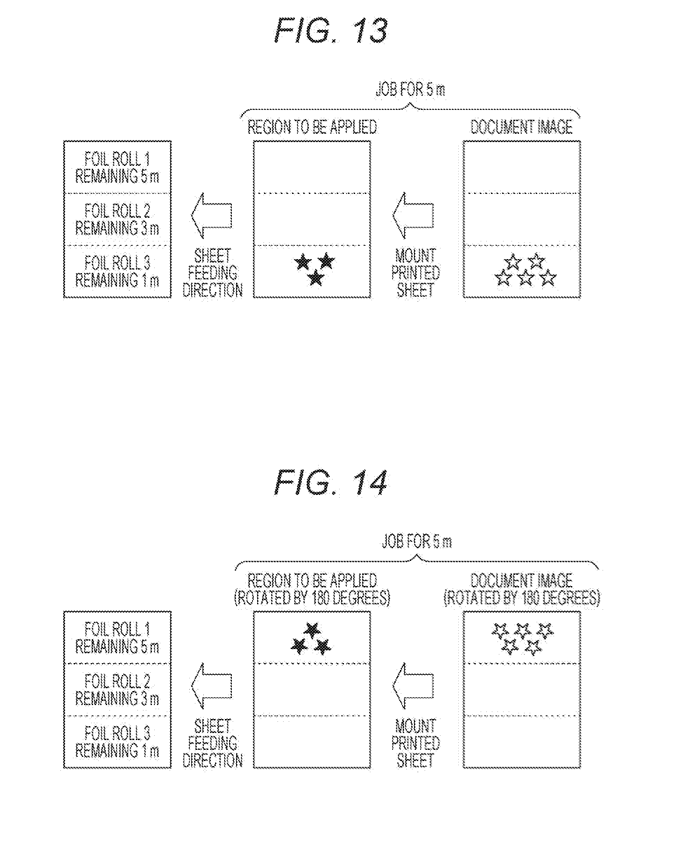

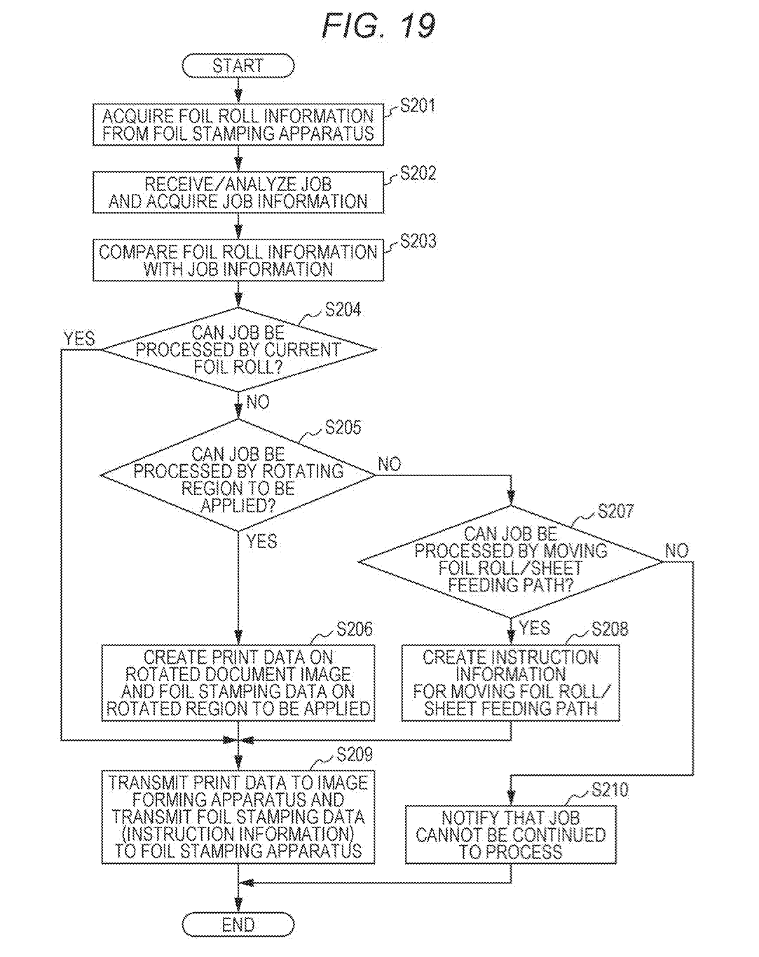

The foil stamping system, the foil stamping control program, and the foil stamping control method according to a second embodiment of the present invention will be described below with reference to FIGS. 11 to 19. FIG. 11 is a schematic diagram illustrating a configuration of the foil stamping system according to the present embodiment, and FIG. 12 is a block diagram illustrating a configuration of an image forming apparatus. Further, FIGS. 13 to 18 are schematic diagrams for explaining the foil stamping method, and FIG. 19 is a flowchart illustrating the operations of the controller according to the present embodiment.

Only foil stamping is performed on the basis of a job according to the first embodiment, but foil stamping can be performed on a printed sheet after the job-based printing. In this case, the foil stamping system is configured of the job generation apparatus 10 for generating and transmitting a job, the controller 20 for processing the job, an image forming apparatus 50 for forming a document image on a sheet on the basis of the job, and the foil stamping apparatus 30 for forming a foil image on the printed sheet on the basis of the job as illustrated in FIG. 11.

The configurations of the job generation apparatus 10, the controller 20, the foil stamping apparatus 30 are similar to those in FIGS. 2A to 4 according to the first embodiment, and the control unit 11 (the image creation unit 11a) in the job generation apparatus 10 creates a document image, designates a region to be applied with an adhesive such as varnish for forming a foil image, and the like.

Further, the control unit 11 (the job generation unit 11b) in the job generation apparatus 10 creates portable document format (PDF) data defining a document image or the like (denoted as print data), and foil stamping data such as TIFF data for designating a region to be applied, and outputs a job including the same to the controller 20.

Further, the control unit 21 (the instructor 21c) in the controller 20 specifies a foil roll having the amount of remaining foil equal to or longer than a region to be applied in the sheet feeding direction and having a width equal to or larger than the region to be applied in the axial direction from among the foil rolls, transmits the print data to the image forming apparatus 51) thereby to instruct to print a document image, and transmits the foil stamping data for designating the region to he applied to the foil stamping apparatus 30 thereby to instruct to stamp foil by the specified foil roll. At this time, when the region to be applied is rotated on the sheet and the rotated region to be applied is within the region to be foil-stamped by the specified foil roll, the document image and the region to be applied are rotated by the same degrees on the sheet and the image data of the rotated document image is transmitted to the image forming apparatus 50, and the foil stamping data for designating the rotated region to be applied is transmitted to the foil stamping apparatus 30.

Further, the varnish application unit 38 in the foil stamping apparatus 30 applies an adhesive such as varnish on the region to be applied defined by the foil stamping data on the sheet printed by the image forming apparatus 50.

Further, the image forming apparatus 50 is multi-functional peripherals (MFP) or the like, and performs an image formation processing on the basis of the print data received from the controller 20. The image forming apparatus 50 is configured of a control unit 51, a storage unit 55, a network I/F unit 56, a display operation unit 57, a print processing unit 58, and the like as illustrated in FIG. 12.

The control unit 51 is configured of a CPU 52 and a memory such as ROM 53 or RAM 54, and the CPU 52 develops a control program stored in the ROM 53 or the storage unit 55 into the RAM 54 and executes the control program thereby to control the operations of the entire image forming apparatus 50.

The storage unit 55 is configured of HDD, SSD, or the like, and stores the program used by the CPU 52 for controlling each unit, the information on the processing functions of the apparatus, the print data received from the controller 20, and the like.

The network I/F unit 56 is configured of MC, modem, or the like, connects the image forming apparatus 50 to the communication network 40, and receives the print data from the controller 20.

The display operation unit 57 is a touch panel provided with a pressure-sensitive operation unit (touch sensor) in which transparent electrodes are arranged in a grid shape on the display unit, displays various screens for the image formation processing, and enables various operations for the image formation processing.

The print processing unit 58 performs a print processing on the basis of the print data. The print processing unit 58 includes an exposure unit for irradiating a laser beam and exposing on the basis of the print data, a photosensitive drum, a development unit, a charging unit, a photosensitive cleaning unit, and a primary transfer roller, and is configured of an image forming unit for forming a toner image of each color CMYK, an intermediate belt rotated by a roller and functioning as intermediate transfer body for carrying the toner image formed by the image forming unit onto a sheet, a secondary transfer roller for transferring the toner image formed on the intermediate belt onto the sheet, a fixing unit for fixing the toner image transferred onto the sheet, carrying units such as sheet feeding roller for carrying a sheet, resist roller, loop roller, inversion roller, and sheet discharging roller, and the like.

FIGS. 11 and 12 illustrate the foil stamping system according to the present embedment by way of example, but the configuration and control of each apparatus can be changed as needed.

For example, FIG. 11 illustrates that the image forming apparatus 50 and the foil stamping apparatus 30 are assumed as separate apparatuses, but the image forming apparatus 50 and the foil stamping apparatus 30 may be assumed as one apparatus.

Further, the first embodiment is configured such that the control unit 21 in the controller 20 is caused to function as the foil roll information acquisitor 21a, the job information acquisitor 21b, the instructor 21c, and the notifier 21d (the CPU 22 in the controller 20 is caused to execute the foil stamping control program), but the control unit 51 in the image forming apparatus 50 can be configured to function as a foil roll information acquisitor, a job information acquisitor, an instructor, and a notifier (the CPU 52 in the image forming apparatus 50 is caused to execute the foil stamping control program).

The foil stamping method according to the present embodiment will be described below. At first, the controller 20 transmits the print data, to the image forming apparatus 50, the print processing unit 58 in the image forming apparatus 50 forms a document image on a sheet according to the print data. The controller 20 then transmits the foil stamping data to the foil stamping apparatus 30, and the varnish application unit 38 in the foil stamping apparatus 30 applies varnish on the printed sheet according to the foil stamping data. Thereafter, the foil stamping unit 39 in the foil stamping apparatus 30 presses/heats a foil roll on the varnish-applied sheet thereby to perform foil stamping.

Here, assuming that three foil rolls (foil rolls 1 to 3) are mounted on the foil stamping unit 39 as illustrated in FIG. 13, it is assumed that the amount of remaining foil of the foil roll 1 is 5 m, the amount of remaining foil of the foil roll 2 is 3 m, and the amount of remaining foil of the foil roll 3 is 1 m. Further, there will be considered a case in winch a job for 5 m instructing to print a document image (white star in the Figure) on a portion corresponding to the foil roll 3 and to apply varnish on a region to be applied (black star in the Figure) is processed. In this case, as in the first embodiment, only the foil roll 3 may be used in the correspondence between the varnish-applied region and the region to be foil-stamped by the foil roll, but the amount of remaining foil of the foil roll 3 is only 1 m for the 5-m job, and thus the foil roll 3 needs to be replaced during the job, and productivity of output materials is reduced.

Thus, according to the present embodiment, a first method is that the control unit 21 (the instructor 21c) in the controller 20 specifies a foil roll with the amount of remaining foil required for processing the job (the remaining amount of 5 m or more here) oil the basis of the foil roll information (such as position, width and the amount of remaining foil of each foil roll) and the job information (such as size of a sheet, and position and size of a region to be applied on the sheet), creates the print data on the rotated document image (rotated by 180 degrees here) and transmits it to the image forming apparatus 50 in order to establish a correspondence between the region to be foil-stamped by the specified foil roll (the foil roll 1 here) and the varnish-applied region, and transmits the foil stamping data on the rotated region to be applied (also rotated by 180 degrees) to the foil stamping apparatus 30 as illustrated in FIG. 14. The print processing unit 58 in the image forming apparatus 50 forms the document image on a sheet according to the print data, the varnish application unit 38 in the foil stamping apparatus 30 applies varnish according to the foil stamping data, and the foil stamping unit 39 operates a foil roll corresponding to the varnish-applied. region thereby to perform foil stamping. Thereby, the foil roll does not need to be replaced for processing the job, and thus productivity of output materials can be improved.

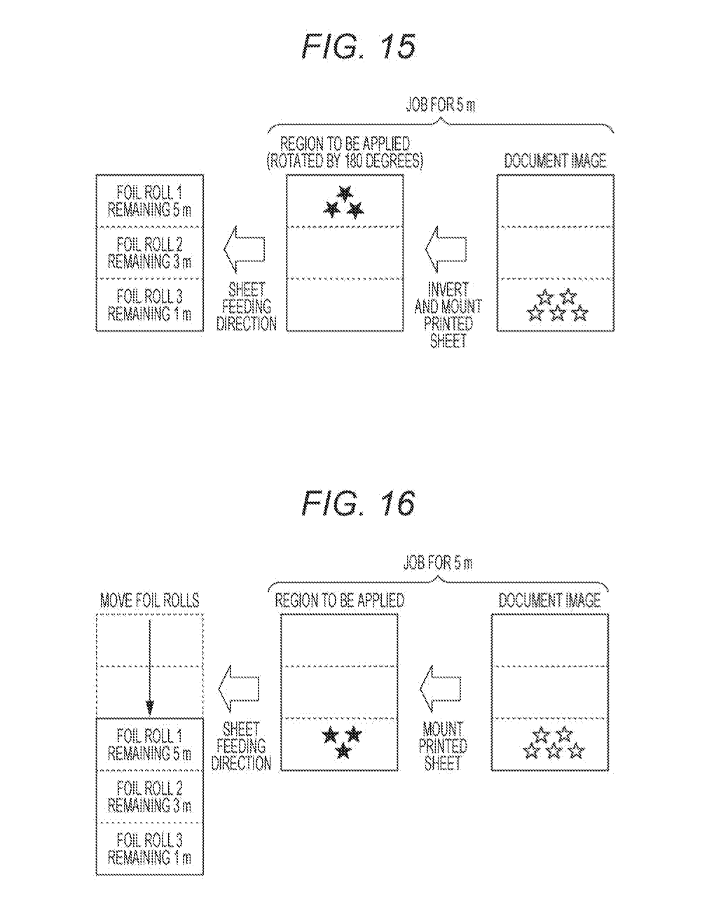

Further, as another example of the first method, the control unit 21 (the instructor 21c) transmits the print data of the job to the image forming apparatus 50, and transmits the instruction information for instructing to rotate a printed sheet by 180 degrees and mount the sheet and the foil stamping data on the rotated region to be applied (rotated by 180 degrees here) to the foil stamping apparatus 30 as illustrated in FIG. 15. The print processing unit 58 in the image forming apparatus 50 forms the document image on the sheet according to the print data, the varnish application unit 38 in the foil stamping apparatus 30 applies varnish according to the foil stamping data on the sheet rotated by 180 degrees and mounted according to the instruction information, and the foil stamping unit 39 operates a foil roll corresponding to the varnish-applied position thereby to perform foil stamping. Also in the method, the foil roll does not need to be replaced for processing the job, and thus productivity of output material can be improved.

Further, a second method is that when the foil stamping unit 39 is configure such that the foil rolls can be moved in the axial direction, the control unit 21 (the instructor 21c) specifies a foil roil with the amount of remaining foil required for processing the job on the basis of the foil roil information and the job information, transmits the print data to the image forming apparatus 50 in order to establish a correspondence between a region to be foil-stamped by the specified foil roll and a varnish-applied region, and transmits the foil stamping data to the foil stamping apparatus 30 and transmits the instruction information for instructing to move the foil rolls as illustrated in FIG. 16. The print processing unit 58 in the image forming apparatus 50 then forms a document image on a sheet according to the print data, the varnish application unit 38 in the foil stamping apparatus 30 applies varnish on the printed sheet according to the foil stamping data, and the foil stamping unit 39 in the foil stamping apparatus 30 moves the foil rolls according to the instruction information and operates a foil roll corresponding to the varnish-applied region thereby to perform foil stamping. Also in the method, the foil roll does not need to be replaced for processing the job, and thus productivity of output materials can be improved.

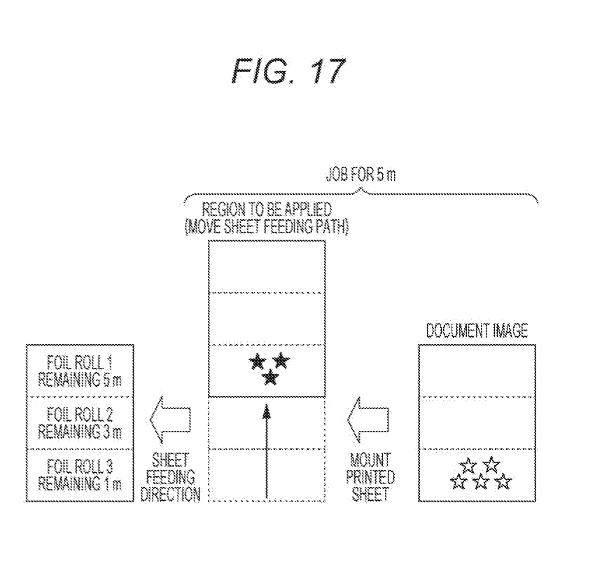

Further, a third method is that when the foil stamping unit 39 is configured such that the sheet feeding path of a sheet can be moved in the axial direction of the foil rolls, the control unit 21 (the instructor 21c) specifies a foil roll with the amount of remaining foil required for processing the job on the basis of the foil roil information and the job information, transmits the print data to the image forming apparatus 50 in order to establish a correspondence between the region to be foil-stamped by the specified foil roll and the varnish-applied region, and transmits the foil stamping data and the instruction information for instructing to move the sheet feeding path to the foil stamping apparatus 30 as illustrated in FIG. 17. The print processing unit 58 in the image forming apparatus 50 then forms a document image on a sheet according to the print data, the varnish application unit 38 in the foil stamping apparatus 30 applies varnish on the printed sheet according to the foil stamping data, and the foil stamping unit 39 in the foil stamping apparatus 30 moves the sheet feeding path of the sheet according to the instruction information and operates a foil roll corresponding to the varnish-applied region thereby to perform foil stamping. Also in the method, the foil roll does not need to he replaced for processing the job, and thus productivity of output materials can be improved.

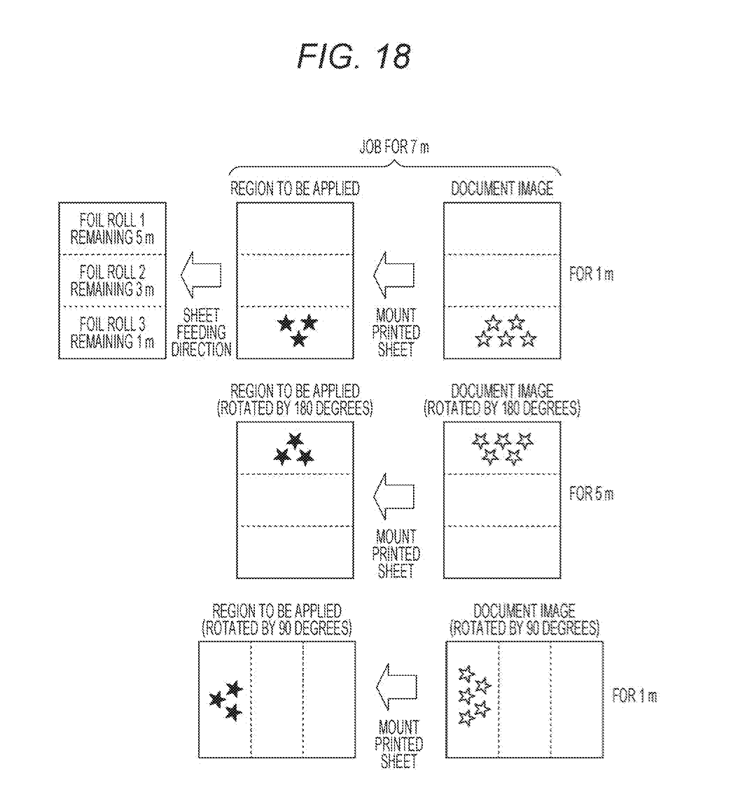

FIGS. 13 to 17 illustrate that a job capable of being processed by only one foil roll is processed, but as in the first embodiment, when the length of a region to be applied designated by the job in the sheet feeding direction is longer than the amount of remaining foil of any foil roll, the above methods can be combined and the foil rolls can be sequentially used thereby to process the job. For example, as illustrated in FIG. 18, when a job for 7 m is processed, the job for 1 m is processed by the foil roll 3, the job for the next 5 m is to rotate a document image and a region to be applied by 180 degrees in the first method and to process them by another foil roll (the foil roll 1 here), and the job for the remaining 1 m is to rotate the document image and the region to be applied by 90 degrees in the first method and to process them by the other foil roll (the foil roll 2 here).

Further, as in the first embodiment, an order of using the foil rolls can be designated by the user on the screen displayed on the display unit 28 or can be designated in any order (descending or ascending order, for example), and the foil rolls can be used from a foil roll with the least remaining amount, or can be used from a foil roll with the most remaining amount, or can be used to be the almost-uniform remaining amounts.

The operations of the controller 20 according to the present embodiment will be described below in detail. The CPU 22 develops the foil stamping control program stored in the ROM 23 or the storage unit 25 into the RAM 24 and executes the control program thereby to perform the processing in each step illustrated in the flowchart of FIG. 19.

At first, the control unit 21 (the foil roll information acquisitor 21a) acquires the foil roil information on position, width and the amount of remaining foil of each foil roll mounted on the foil stamping unit 39 from the foil stamping apparatus 30 (S201).

The control unit 21 (the job information acquisitor 21b) then receives a job from the job generation apparatus 10 and analyzes the job, and acquires the job information on size of a sheet used for processing the job, position and size of a region to be applied on the sheet, and the like (S202).

The control unit 21 (the instructor 21c) then compares the foil roll information with the job information (S203), and determines whether the job can be processed by a current foil roll (whether foil stamping for the length designated by the job can be performed without replacement of the foil roll) (S204). When the job can be processed by the current foil roll (Yes in S204), rotation of a document image and a region to be applied or movement of a foil roll/sheet feeding path is not required, and thus the control unit 21 (the instructor 21c) transmits the print data included in the job to the image forming apparatus 50 and transmits the foil stamping data included in the job to the foil stamping apparatus 30 (S209).

When the job cannot be processed by the current foil roll (No in S204), the control unit 21 (the instructor 21c) determines whether the job can be processed by rotating the document image and the region to be applied (S205). When the job can be processed by rotating the document image and the region to be applied (Yes in S205), the control unit 21 (the instructor 21c) creates the print data on the rotated document image, creates the foil stamping data on the rotated region to be applied (S206), transmits the created print data to the image forming apparatus 50, and transmits the created foil stamping data to the foil stamping apparatus 30 (S209).

On the other hand, when the job cannot be processed even by rotating the document image and the region to be applied (No in S205), the control unit 21 (the instructor 21c) determines whether the job can be processed by moving the foil roll or the sheet feeding path in the axial direction (S207). When the job can be processed by moving the foil roll/sheet feeding path (Yes in S207), the control unit 21 (the instructor 21c) creates the instruction information for moving the foil roll/sheet feeding path in the axial direction (S208), transmits the print data included in the job to the image forming apparatus 50, and transmits the foil stamping data included in the job and the created instruction information to the foil stamping apparatus 30 (S209).

Further, when the job cannot be processed even by moving the foil roll/sheet feeding path (No in S207), the control unit 21 (the notifier 21d) displays a message that the job cannot be continued to process (the foil roll needs to be replaced for processing the job) on the display unit 28 and notifies it to the user (S210).

The image forming apparatus 50 receives the print data from the controller 20 and prints the document image on the sheet, the foil stamping apparatus 30 receives the foil stamping data and as needed, the instruction information from the controller 20, the varnish application unit 38 applies an adhesive such as varnish on the sheet printed with the document image according to the foil stamping data, and the foil stamping unit 39 moves the foil roll/sheet feeding path in the axial direction according to the instruction information as needed, and performs foil stamping by a predetermined foil roil thereby to form a foil image.

In this way, according to the present embodiment, the document image and the region to be applied are rotated and the foil roll/sheet feeding path is moved thereby to control foil stamping in order to further reduce the number of times of replacement of foil rolls on the basis of the foil roil information acquired from the foil stamping apparatus 30 and the job information acquired by analyzing the job, thereby restricting operation stop of the foil stamping apparatus due to used-up foil roil and improving productivity of output materials.

The present invention is not limited to the embodiments, and the configuration or control thereof can be changed as needed without departing from the spirit of the present invention.

For example, three foil rolls with the same width are illustrated in the embodiments by way of example, but the number or width of foil rolls is not limited to the illustrated configurations, and the foil stamping control according to the present invention can also be applied for any number of foil rolls with any width.

Further, either control of to rotate a region to be applied or to move a foil roll or a sheet feeding path is performed according to the embodiments by way of example, but rotation of a region to be applied, movement of a foil roll, and movement of a sheet feeding path can be arbitrarily combined.

The present invention can be used for a foil stamping system for forming a foil image by applying an adhesive on a sheet and stamping foil thereon, a foil stamping control method for controlling foil stamping, a foil stamping control program, and a foil stamping control program therein.

Although embodiments of the present invention have been described and illustrated in detail, it is clearly understood that the same is by way of illustration and example only and not limitation, the scope of the present invention should be interpreted by terms of the appended claims.

What is claimed is:

1. A foil stamping system comprising a foil stamping apparatus capable of arranging and mounting a plurality of foil rolls about a direction orthogonal to a sheet feeding direction of a sheet in plane of the sheet and directed for forming a foil image by applying an adhesive on the sheet and stamping foil thereon, and a hardware processor,
wherein the hardware processor includes:
a foil roll information acquisitor that acquires foil roll information including position, width, and the amount of remaining foil of each of the foil rolls from the foil stamping apparatus;
a job information acquisitor that receives and analyzes a job, and acquires job information including size of a sheet used for processing the job, and position and size of a region to be applied with the adhesive in order to form the foil image based on the job on the sheet; and
an instructor that specifies a foil roll having the amount of remaining foil equal to or longer than the region to be applied in the sheet feeding direction and with a width equal to or larger than the region to be applied in the axial direction from the foil rolls on the basis of the foil roll information and the job information, transmits data for designating the region to be applied to the foil stamping apparatus, and instructs the foil stamping apparatus to perform foil stamping by the specified foil roll.

2. The foil stamping system according to claim
wherein when the region to he applied is rotated on the sheet and the rotated region to be applied is within a region to be foil-stamped by the specified foil roil, the instructor transmits data for designating the rotated region to be applied to the foil stamping apparatus.

3. The foil stamping system according to claim 2, further comprising an image forming apparatus that prints a document image on the sheet,
wherein the instructor rotates the document image by the same degrees as the region to be applied on the sheet, and transmits image data on the rotated document image to the image forming apparatus thereby to instruct the image forming apparatus to print.

4. The foil stamping system according to claim
wherein the foil stamping apparatus can move the foil rolls in the axial direction, and
when the fil rolls are moved in the axial direction and the region to be applied is within a region to be foil-stamped by the specified foil roil, the instructor transmits instruction information for instructing to move the foil rolls to the foil stamping apparatus.

5. The foil stamping system according to claim 1,
wherein the foil stamping apparatus can move a sheet feeding path of the sheet in the axial direction during foil stamping, and
when the sheet feeding path of the sheet is moved in the axial direction and the region to be applied is within a region to be foil-stamped by the specified foil roll, the instructor transmits instruction information for instructing to move the sheet feeding path of the sheet to the foil stamping apparatus.

6. The foil stamping system according to claim 2,
wherein the instructor specifies two or more foil rolls for which the total amount of remaining foil is equal to or longer than the region to be applied in the sheet feeding direction from among the foil rolls, designates the two or more foil rolls in a predetermined order, and instructs the foil stamping apparatus to sequentially perform foil stamping by the designated foil rolls.

7. The foil stamping system according to claim 1,
wherein the hardware processor further includes:
a notifier that notifies a message that the foil roll needs to be replaced for processing the job when the foil roll cannot be specified.

8. A foil stamping control method in a foil stamping system including a foil stamping apparatus capable of arranging and mounting a plurality of foil rolls about a direction orthogonal to a sheet feeding direction of a sheet in plane of the sheet and directed for forming a foil image by applying an adhesive on the sheet and stamping foil thereon, and a hardware processor,
wherein the hardware processor performs:
a foil roll information acquisition processing of acquiring foil roll information including position, width, and the amount of remaining foil of each of the foil rolls from the foil stamping apparatus;
a job information acquisition processing of receiving and. analyzing a job, and acquiring job information including size of a sheet used for processing the job, and position and size of a region to be applied with the adhesive in order to form the foil image based on the job on the sheet; and
an instruction processing of specifying a foil roll having the amount of remaining foil equal to or longer than the region to be applied in the sheet feeding direction and with a width equal to or larger than the region to be applied in the axial direction from the foil rolls on the basis of the foil roll information and the job information, transmitting data for designating the region to be applied to the foil stamping apparatus, and instructing the foil stamping apparatus to perform foil stamping by the specified foil roll, and
the foil stamping apparatus performs:
an application processing of receiving the data and applying the adhesive on the region to be applied on the sheet; and
a foil stamping processing of stamping foil on the region to be applied by the specified foil roil.

9. The foil stamping control method according to claim 8,
wherein when the region to be applied is rotated on the sheet and the rotated region to be applied is within a region to be foil-stamped by the specified foil roll, data for designating the rotated region to be applied is transmitted to the foil stamping apparatus in the instruction processing, and
the adhesive is applied on the rotated region to be applied in the application processing.

10. The foil stamping control method according to claim 9,
wherein the foil stamping system includes an image forming apparatus that prints a document image on the sheet,
the document image is rotated on the sheet by the same degrees as the region to be applied and image data on the rotated document image is transmitted to the image forming apparatus thereby to instruct the image forming apparatus to print in the instruction processing, and
the image forming apparatus receives the image data and performs a print processing of printing the rotated document image on the sheet.

11. The foil stamping control method according to claim 8,
wherein the foil stamping apparatus can move the foil rolls in the axial direction,
when the foil rolls are moved in the axial direction and the region to be applied is within a region to be foil-stamped by the specified, foil roll, instruction information for instructing to move the foil rolls is transmitted to the foil stamping apparatus in the instruction processing, and
the foil rolls are moved in the axial direction according to the instruction information and then foil is stamped on the region to be applied by the specified foil roll in the foil stamping processing.

12. The foil stamping control method according to claim 8,
wherein the foil stamping apparatus can move a sheet feeding path of the sheet in the axial direction when stamping foil,
when the sheet feeding path of the sheet is moved in the axial direction and the region to be applied is within a region to be foil-stamped by the specified foil roll, instruction information for instructing to move the sheet feeding path of the sheet is transmitted to the foil stamping apparatus in the instruction processing, and
the sheet feeding path of the sheet is moved in the axial direction according to the instruction information and foil is stamped on the region to be applied by the specified foil roll in the foil stamping processing.

13. The foil stamping control method according to claim 9,
wherein two or more foil rolls for which the total amount of remaining foil is equal to or longer than the region to be applied in the sheet feeding direction are specified from among the foil rolls, and the two or more foil rolls are designated in a predetermined order thereby to sequentially instruct the foil stamping apparatus to stamp foil by the designated foil rolls in the instruction processing.

14. The foil stamping control method according to claim 8,
wherein the hardware processor further executes a notification processing of notifying a message that the foil roll needs to be replaced for processing the job when the foil roll cannot be specified.

15. A non-transitory recording medium storing a computer readable foil stamping control program operated by a hardware processor in a foil stamping system including a foil stamping apparatus capable of arranging and mounting a plurality of foil rolls about a direction orthogonal to a sheet feeding direction of a sheet in plane of the sheet and directed for forming a foil image by applying an adhesive on the sheet and stamping foil thereon, and the hardware processor, the foil stamping control program causing the hardware processor to perform:
a foil roll information acquisition processing of acquiring foil roll information including position, width, and the amount of remaining foil of each of the foil rolls from the foil stamping apparatus;
a job information acquisition processing of receiving, and analyzing a job, and acquiring job information including size of a sheet used for processing the job, and position and size of a region to be applied with the adhesive in order to form the foil image based on the job on the sheet; and
an instruction processing of specifying a foil roll having the amount of remaining foil equal to or longer than the region to be applied in the sheet feeding direction and with a width equal to or larger than the region to be applied in the axial direction from the foil rolls on the basis of the foil roll information and the job information, transmitting data for designating the region to be applied to the foil stamping apparatus, and instructing the foil stamping apparatus to perform foil stamping by the specified foil roll.

16. The non-transitory recording medium storing a computer readable foil stamping control program according to claim 15,
wherein when the region to be applied is rotated on the sheet and the rotated region to be applied is within a region to be foil-stamped by the specified foil roll, data for designating the rotated region to be applied is transmitted to the foil stamping apparatus in the instruction processing.

17. The non-transitory recording medium storing a computer readable foil stamping control program according to claim 16,
wherein the foil stamping system includes an image forming apparatus that prints a document image on the sheet, and
the document image is rotated on the sheet by the same degrees as the region to be applied and image data on the rotated document image is transmitted to the image forming apparatus thereby to instruct the image forming apparatus to print in the instruction processing.

18. The non-transitory recording medium storing a computer readable foil stamping control program according to claim 15,
wherein the foil stamping apparatus can move the foil rolls in the axial direction, and
when the foil rolls are moved in the axial direction and the region to be applied is within a region to be foil-stamped by the specified foil roil, instruction information for instructing to move the foil rolls is transmitted to the foil stamping apparatus in the instruction processing.

19. The non-transitory recording medium. storing a computer readable foil stamping control program according to claim 15,
wherein the foil stamping apparatus can move a sheet feeding path of the sheet in the axial direction when stamping foil, and
when the sheet feeding path of the sheet is moved in the axial direction and the region to be applied is within a region to be foil-stamped by the specified foil roll, instruction information for instructing to move the sheet feeding path of the sheet is transmitted to the foil stamping apparatus in the instruction processing.

20. The non-transitory recording medium storing a computer readable foil stamping control program according to claim 16,
wherein two or more foil rolls for which the total amount of remaining foil is equal to or longer than the region to be applied in the sheet feeding direction are specified from among the foil rolls, and the two or more foil rolls are designated in a predetermined order thereby to sequentially instruct the foil stamping apparatus to stamp foil by the designated foil rolls in the instruction processing.

21. The non-transitory recording medium storing a computer readable foil stamping control program according to claim 15, the foil stamping control program causing the hardware processor to further execute a notification processing of notifying a message that the foil roll needs to be replaced for processing the job when the foil roll cannot be specified.
